(19) United States
(12) Patent Application Publication
(10) Pub. No.: US 2024/0143120 A1
(43) Pub. Date: May 2, 2024

(54) TOUCH SCREEN PANEL AND MANUFACTURING METHOD THEREFOR

(71) Applicant: DONGWOO FINE-CHEM CO., LTD., Jeollabuk-do 54631 (KR)

(72) Inventors: Sang-Jin PARK, Gyeonggi-do (KR); Dong-Jin SON, Chungcheongnam-do (KR); Jin-Ho BAE, Gyeonggi-do (KR)

(21) Appl. No.: 18/278,098

(22) PCT Filed: Apr. 13, 2022
(86) PCT No.: PCT/KR2022/003496

§ 371 Date: Aug. 21, 2023

(30) Foreign Application Priority Data
Mar. 31, 2021 (KR) 10-2021-0041585

(51) Int. Cl. G06F 3/044

(52) U.S. Cl. CPC G06F 3/0446; G06F 2203/04102; G06F 2203/04103

(57) ABSTRACT

The present invention relates to a touch screen panel and a manufacturing method therefor, wherein a black matrix pattern is formed after a black matrix layer is formed on an electrode layer, and the electrode layer is etched using the black matrix pattern to form an electrode pattern. Thus, the touch screen panel includes a structure in which a black matrix having a pattern corresponding to the electrode pattern is disposed on an electrode.

### TECHNICAL FIELD

The present disclosure relates to a touch screen panel having improved visibility, and a method of manufacturing the touch screen panel.

### BACKGROUND ART

As a touch input type is spotlighted as the next input type, there are attempts to introduce the touch input type into more various electronic devices. Accordingly, a touch sensor that can be applied to various environments and can accurately sense a touch is also being actively studied and developed.

A touch screen panel, which is a device that recognizes a screen touch or a gesture of a user as input information, is mounted and widely used on personal mobile electronic devices such as a smartphone and a tablet PC. A touch screen panel is usually disposed and used close to a device that displays images such as a display panel, and in general, uses apply touch input for images displayed on a display panel.

A touch screen panel generally includes a touch sensing electrode for sensing touch input by a user, and a transparent electrode made of a transparent conductive material such as indium tin oxide (ITO) is used as the touch sensing electrode of a touch screen panel so that a user sees images that are displayed on a display panel.

However, ITO that is used as the touch sensing electrode of a touch screen panel is lower in flexibility than metallic materials. Accordingly, when a touch screen panel using ITO as the material of a touch sensing electrode is applied to a flexible display device, cracks may be generated in the ITO, so poor quality of the touch screen panel may be problematic. Further, since ITO has a high resistance value in comparison to metallic materials, when a touch screen panel using ITO as the material of a touch sensing electrode is applied to a large-area display device, there may be a problem with driving the touch screen panel due to the high resistance value of the ITO. Further, transparent conductive oxides such as ITO have another problem of low transmittance.

Methods of using a metal electrode for solving these problems are being studied, but there is a problem that an electrode pattern is shown in a display due to the reflectivity of metal and visibility is correspondingly deteriorated.

Meanwhile, a structure in which a connecting electrode is formed first, then an insulating film and a contact hole are formed, and a first sensing pattern and a second sensing pattern are formed on a substrate has been disclosed in Korean Patent No. 10-1022087, but there is a problem the visibility is deteriorated because a metal pattern is used. Further, pattering is performed usually through a lithography process when forming a pattern, but there is a problem that the process steps are complicated such as separately removing a photosensitive resist.

### DISCLOSURE

### Technical Problem

The present disclosure has been made in an effort to solve the problems of the related art described above and an objective of the present disclosure is to provide a touch screen panel that can simplify a process because an electrode pattern and a black matrix pattern are formed by simultaneously generally etching an electrode layer and a black matrix layer, accordingly, enables black matrixes of a pattern type corresponding to the electrode pattern to be disposed on electrodes, and can improve reflective visibility of a metal electrode because the electrode pattern and the black matrix pattern are the same in shape and size, and a method of manufacturing the touch screen panel.

However, the objectives of the present disclosure are not limited to the objectives described above and other objectives will be clearly understood by those skilled in the art from the following description.

### Technical Solution

In order to achieve the objectives, the present disclosure provides a touch screen panel that includes: a base; first electrode formed in a first pattern type on the base; an insulating layer formed on the base on which the first electrodes are formed; and second electrode formed in a second pattern type on the insulating layer, wherein black matrixes of a pattern type corresponding to one or more electrodes selected from the first electrodes and the second electrodes are formed on the electrodes.

Further, the present disclosure provides a method of manufacturing a touch screen panel that includes: a step of forming first electrodes in a first pattern type on a base; a step of forming an insulating layer on the base on which the first electrodes are formed; and a step of forming second electrodes in a second pattern type on the insulating layer, wherein one or more electrodes selected from the first electrodes and the second electrodes are formed by a pattern forming method including: a step of forming an electrode layer; a step of forming a black matrix layer on the electrode layer; a step of forming a black matrix pattern by patterning the black matrix layer; and a step of forming an electrode pattern of a pattern type corresponding to the black matrix pattern by etching the electrode layer using the black matrix pattern.

### Advantageous Effects

The touch screen panel of the present disclosure is for improving visibility by reducing reflectivity of an electrode by forming a black matrix on the electrode in order to solve the problem that an electrode pattern is shown due to the reflectivity of an electrode positioned in a display region. In detail, the present disclosure can provide a touch screen panel that makes it possible to simplify a process because a process for removing a photoresist is omitted by using a black matrix as a photoresist in photolithography for electrode patterning, in which black matrixes of a pattern type corresponding to the electrode pattern are disposed on electrodes, and in which reflective visibility of an electrode is further improved because the electrode pattern and the black matrix pattern are the same in shape and size, and a method of manufacturing the touch screen panel.

### DESCRIPTION OF DRAWINGS

FIG. 1 is a flowchart for describing a method of manufacturing a touch screen panel of the present disclosure.

FIG. 2 is a flowchart for describing a method of manufacturing an electrode pattern and a black matrix pattern in the method of manufacturing a touch screen panel of the present disclosure.

FIG. 3a to FIG. 3c are cross-sectional views of touch screen panels according to embodiment of the present disclosure.

FIG. 4a to FIG. 4e are plan views and enlarged views corresponding to respective manufacturing processes of a screen panel according to an embodiment of the present disclosure.

FIG. 5 is a cross-sectional view of the section I-II of the region A in FIG. 4e.

FIG. 6a to FIG. 6c are cross-sectional views for describing a manufacturing process of a touch screen panel having a structure in which a second black matrix is formed on a second electrode according to an embodiment of the present disclosure.

FIG. 7a to FIG. 7c are cross-sectional views for describing a manufacturing process of a touch screen panel having a structure in which a first black matrix is formed on a first electrode according to an embodiment of the present disclosure.

FIG. 8a to FIG. 8c are cross-sectional views for describing a manufacturing process of a touch screen panel having a structure in which a first black matrix and a second black matrix are respectively formed on a first electrode and a second electrode according to an embodiment of the present disclosure.

FIG. 9 shows color coordinates showing reflective color schemes, that is, REFLECTIVE COLOR SCHEMES ACCORDING TO CuO Split, of an embodiment of the present disclosure and a comparative example.

The meanings of reference numerals in the figures are as follows.
100: base
210: first electrode 220: second electrode
300: insulating layer
410: first black matrix 420: second black matrix
510, 520: photosensitive resist
600: protective layer

### BEST MODE

Hereafter, embodiments of the present disclosure are described in more detail with reference to drawings. However, the accompanying drawings of this specification exemplify preferred embodiments and help easy understanding of the spirit of the present disclosure together with the present disclosure described above, so the present disclosure should not be construed as being limited to those in the drawings. Further, some components may be exaggerated, contracted, or omitted in the drawings for the convenience of description. Further, in the accompanying drawings, components irrelevant to the description will be omitted in order to obviously describe the present disclosure, and similar reference numerals will be used to describe similar components throughout the specification.

The terms used herein are provided to describe embodiments and implementation examples without limiting the present disclosure. In the specification, a singular form includes a plural form unless specifically stated in the sentences.

The terms “comprises” and/or “comprising” used herein do not exclude that one or more other components, steps, operations, and/or elements exist or are added other than the stated component, step, operation, and/or element. Like reference numerals indicate like components throughout the specification and components shown in the drawings may be exaggerated, contracted, or omitted for smooth description.

When an element is referred to as being “connected with” another element throughout the specification, it may be “directly connected” to the other element and may also be “electrically connected” to the other element with another element intervening therebetween.

Throughout the specification, when a member is disposed “on” another member, it may be disposed not only in contact with another member, but with another member between the two members.

In the specification, the terms “approximately”, “substantially”, etc. are used as meanings at values or close to the values when inherent manufacturing and substance allowable errors are proposed in the stated meanings, and are used to prevent unscrupulous infringers from unfairly use the matters stating accurate or absolute values to help understand the present disclosure.

The terms of degrees “step that ˜” or “step of ˜” used throughout the specification of the present disclosure do not mean “step for ˜”.

Throughout the specification of the present disclosure, the term “combination(s) thereof” included in Markush format expressions mean one or more composites or combinations selected from a group of the components described in the Markush format expressions and mean including one or more selected from a group of the components.

The term “A and/or B” means “A or B, or A and B” throughout the specification of the present disclosure.

An aspect of the present disclosure provides a touch screen panel that includes: a base 100; first electrodes 210 formed in a first pattern type on the base 100; an insulating layer 300 formed on the base 100 on which the first electrodes 210 are formed; and second electrodes 220 formed in a second pattern type on the insulating layer 300, in which black matrixes 410 and 420 of pattern types corresponding to one or more electrodes selected from the first electrodes 210 and the second electrodes 220 are disposed on the electrodes.

The touch screen panel of the present disclosure, which is for improving visibility by reducing reflectivity of an electrode by forming a black matrix on the electrode in order to solve the problem that an electrode pattern is shown due to the reflectivity of an electrode, can further improve visibility by forming a black matrix of a pattern type corresponding to an electrode pattern on an electrode in the same shape and size as the electrode pattern and a black matrix pattern.

A transparent insulating material such as glass or plastic may be used for the base 100.

In detail, a film having excellent transparency, mechanical strength, and thermal stability may be used for the base. For example, a film made of thermoplastic resin such as: polyester-based resin such as polyethylene terephthalate, polyethylene isophthalate, polyethylene naphthalate, and polybutylene terephthalate; cellulose-based resin such as diacetyl cellulose and triacetyl cellulose; polycarbonate-based resin; acryl-based resin such as polymetyl (meta) acrylate and polyetyl (meta) acrylate; styrene-based resin such as polystyrene and an acrylonitrile-styrene compolymer; polyolefin-based resin such as polyethylene, polypropylene, polyolefin having a cyclo-based or norbornene structure, and an ethylene-propylene compolymer; vinyl chloride resin; amide-based resin such as nylon and aromatic polyamide; imide-based resin; polyethersulfone-based resin; sulfone-based resin; polyetheretherketone-based resin; polyphenylene sulfide-based resin; vinyl alcohol-based resin; vinylidene chloride-based resin; vinyl butyral-based resin; allylate-based resin; polyoxymethylene-based resin; and epoxy-based resin, and a film made of blends of thermoplastic resin may be used. Further, a film made of thermosetting resin such as (meta) acryl-based, urethane-based, acryl urethane-based, epoxy-based, and silicon-based resin, or UV curable resin may also be used.

The thickness of the base 100 may be appropriately determined, but generally, may be 0.1 to 500 μm, and more preferably, may be 0.1 to 100 μm in terms of workability such as strength or handling convenience, thinness, etc.

Further, any material may be used for the first electrode 210 and the second electrode 220 without specific limitation as long as it is metal or a metal oxide. For example, a metal material including molybdenum, argentum, aluminum, copper, palladium, aurum, platinum, zinc, tin, titanium, or an alloy thereof; or a transparent metal oxide selected from a group of indium tin oxide (ITO), indium zinc oxide (IZO), zinc oxide (ZnO), indium zinc tin oxide (IZTO), and cadmium tin oxide (CTO) may be used.

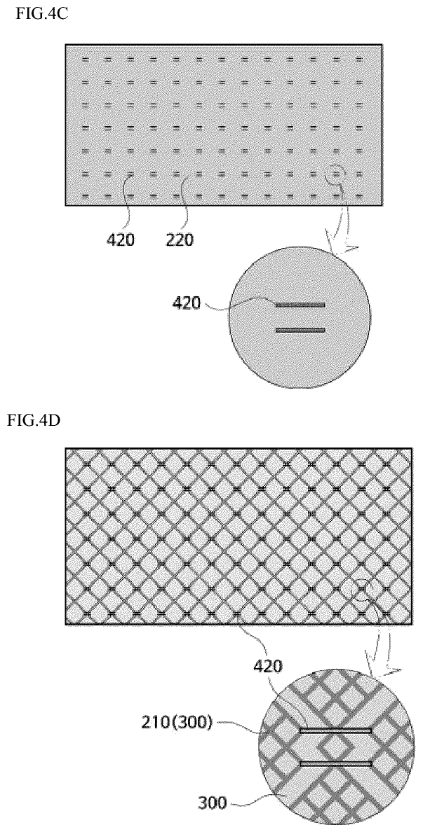

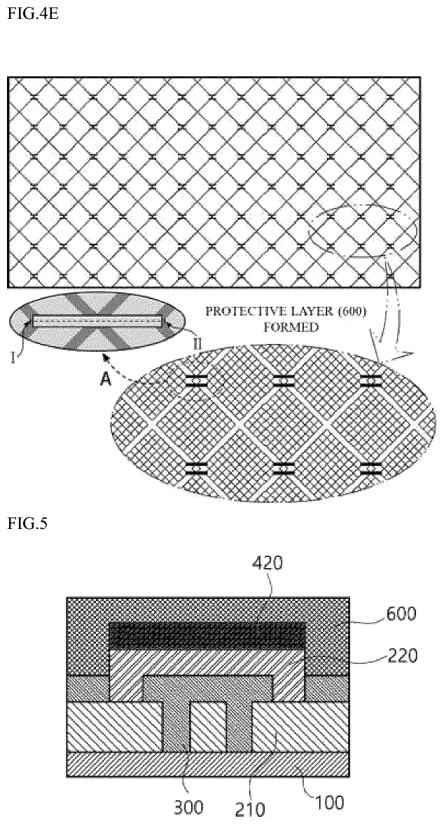

The first electrodes 210 are formed in a first pattern type on the base 100, and as shown in FIG. 4a, the first pattern may be a lattice pattern, and in detail, as shown in the enlarged view of FIG. 4a, may be composed of many first electrode patterns arranged in a first direction and connected to each other in one pattern. Further, referring to FIG. 4e, the first electrode 210 patterns may be electrically connected to each other and formed in the first direction, and may be formed as independent lattice patterns.

The second electrodes 220 are formed in a second pattern type on the insulating layer 300 and the second pattern may be a lattice pattern or may be bar-type connection pattern electrically connecting adjacent first electrode patterns. Many second electrodes may be arranged in a second direction crossing the first direction and may not be connected to each other. For example, when the first direction is a transverse direction, the second direction may be a longitudinal direction.

The insulating layer 300 may be formed between the first electrode patterns and between the first electrodes and the second electrodes. Further, the insulating layer 300, as shown in FIG. 4b, may include contact holes for electrically connecting the first electrodes and the second electrodes.

Insulating materials known in the art may be used as the material of the insulating layer 300 without limitation, and for example, a metal oxide such as a silicon oxide, or a photosensitive resin composite or thermosetting resin composite including acryl-based resin may be used. Alternatively, the insulating layer 300 may be formed using an inorganic substance such as a silicon oxide (SiOx), and in this case, the insulating layer 300 may be formed by sputtering, etc.

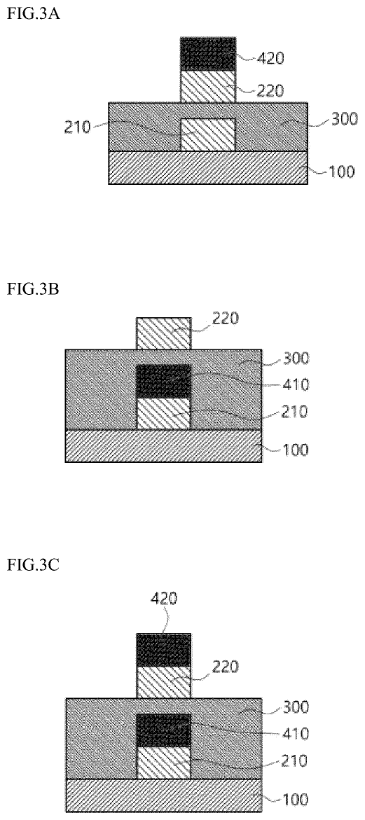

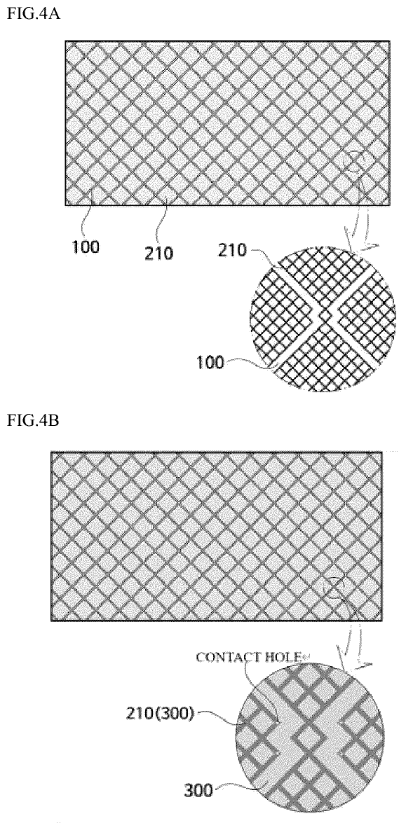

The black matrixes 410 and 420 may be formed in a black matrix pattern corresponding to the pattern shape and size of electrodes on the first electrodes and/or the second electrodes to reduce reflectivity of the electrodes. When an electrode is larger than a black matrix, the edge of the electrode is reflected and visibility is deteriorated, and when a black matrix is larger than an electrode, visibility may be deteriorated due to the size of the black matrix. Accordingly, it is possible to further improve the visibility of a touch panel screen by making the pattern shapes and sizes (widths) of an electrode and a black matrix. In detail, a first black matrix 410 having the same pattern shape and width may be formed on the first electrode pattern 210, as shown in FIG. 3b, a second black matrix 420 having the same pattern shape and width may be formed on the second electrode pattern 220, as shown in FIG. 3a, and both of a first black matrix 410 having the same pattern shape and width and a second black matrix 420 having the same pattern shape and width may be formed on the first electrode pattern 210 and the second electrode pattern 220, respectively.

Further, the black matrix may be formed using a black photosensitive resin composite including a coloring agent, alkali soluble resin, a multifunctional monomer, a photoinitiator, a surfactant, a solvent, other additives, etc. that are generally used in the field.

Further, the touch screen panel of the present disclosure, as shown in FIG. 5, may further include a protective layer 600. The protective layer 600 may be formed may be formed on the panel on which the second electrode 220 pattern and/or the second black matrix 420 pattern is formed, and may be composed of a first region formed in one direction and a second region that is a region thicker than the first region except for the first region.

The protective layer 600 is made of an insulating material and is formed to cover the first electrodes 210, the second electrodes 220, the insulating layer 300, the first black matrixes 410, and the second black matrixes 420, thereby performing a function of insulating them from the outside and protecting them. For example, the protective layer 600 may be formed in a single layer or a plurality of layers of two or more layers.

Further, another aspect of the present disclosure provides a method of manufacturing a touch screen panel that includes: a step of forming first electrodes in a first pattern type on a base (S10); a step of forming an insulating layer on the base on which the first electrodes are formed (S20); and a step of forming second electrodes in a second pattern type on the insulating layer (S30),

in which one or more electrodes selected from the first electrodes and the second electrodes are formed by a pattern forming method including: a step of forming an electrode layer (S100); a step of forming a black matrix layer on the electrode layer (S200); a step of forming a black matrix pattern by patterning the black matrix layer (S300); and a step of forming an electrode pattern of a pattern type corresponding to the black matrix pattern by etching the electrode layer using the black matrix pattern.

Further, the manufacturing method, as shown in FIG. 4e, may further include a step of forming a protective layer 600 after the step of forming second electrodes.

The method of manufacturing a touch panel screen according to the present disclosure uses a photosensitive resist for a black matrix as a photosensitive resist in a photolithography process for electrode patterning, so it is possible to simultaneously perform patterning of electrodes and patterning of black matrixes and it is possible to omit a process of removing a photosensitive resist, whereby it is possible to simplify the entire manufacturing process.

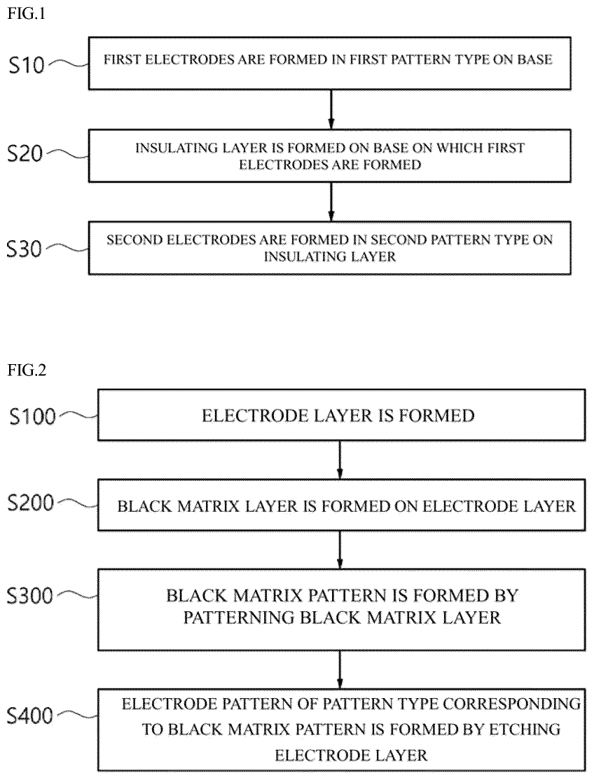

FIG. 1 is a flowchart for describing a method of manufacturing a touch screen panel of the present disclosure and FIG. 2 is a flowchart for describing a method of manufacturing an electrode pattern and a black matrix pattern in the method of manufacturing a touch screen panel of the present disclosure.

Hereafter, various embodiments of a touch screen panel according to the present disclosure and a method of manufacturing the touch screen panel are described in detail with reference to the accompanying drawings.

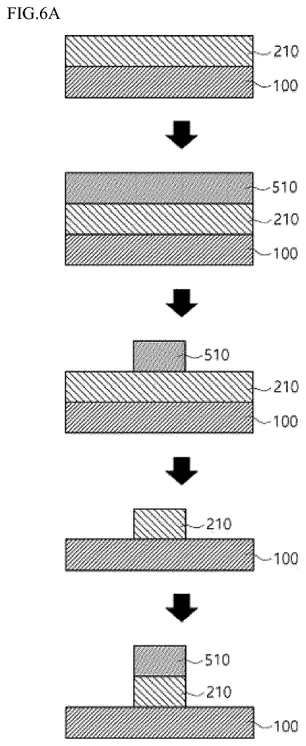

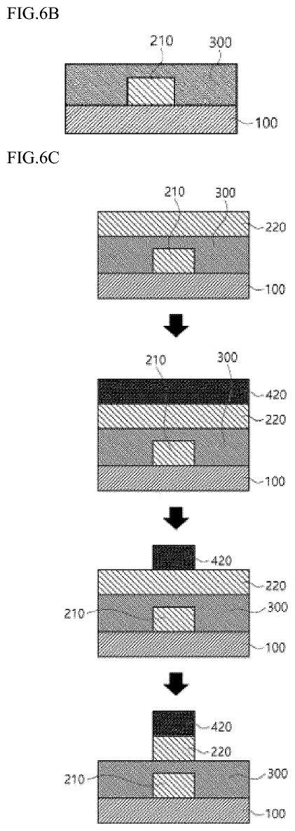

FIG. 4a to FIG. 4e and FIG. 6a to FIG. 6e show step by step a process of manufacturing a touch screen panel including a structure in which second black matrixes 420 are formed on second electrodes 220 in an embodiment of the present disclosure, and FIG. 5 is a cross-sectional view of the section I-II of the region A in the enlarged view of FIG. 4e.

First, first electrodes 210 are formed in a first pattern type on a base 100 (S10). Referring to FIG. 6a, first electrodes 210 are formed on a base 100 and patterning is applied to the first electrodes 210 through photolithography using a photosensitive resist 510, whereby a first electrode pattern layer can be formed. In this case, the photosensitive resist 510 is removed after the first electrode pattern layer 210 is formed.

As shown in FIG. 4a, the first pattern may be a lattice pattern, and in detail, as shown in the enlarged view of FIG. 4a, may be composed of a plurality of first electrodes arranged in a first direction and connected to each other into one pattern.

Next, an insulating layer 300 is formed on the base 100 on which the first electrodes 210 are formed (S20). Referring to FIG. 4b and FIG. 6b, the insulating layer 300 is applied to the base 100 and the first electrodes 210, so it can fill the portions between the plurality of first electrodes 210 connected in a lattice pattern.

Coating known in the art may be used as the method of applying the insulating layer 300. For example, spin coating, die coating, spray coating, roll coating, screen coating, slit coating, deep coating, gravure coating, etc. may be used.

The insulating layer 300 may be formed to have a plurality of insulating patterns. The plurality of insulating patterns may have a plurality of openings for electrically connecting first electrodes and second electrodes to each other, and in detail, the insulating layer 300, as shown in the enlarged view of FIG. 4b and FIG. 5, may be patterned to have contact holes for at least partially connecting the first electrodes 210 and the second electrodes 220 to each other and may also be patterned such that the insulating layer 300 is formed like islands at the joints of many first electrodes 210.

Next, second electrodes 220 are formed in a second pattern type on the insulating layer 300 (S30). The second pattern may be a lattice pattern or a bar type connecting pattern electrically connecting a plurality of adjacent first electrode patterns, and in detail, as shown in FIG. 4d, may be composed of a plurality of second electrodes 220 arranged in a second direction crossing the first direction and not connected to each other.

As for the second electrodes 220, as shown in FIG. 4c, FIG. 4d, and FIG. 6c, a second electrode layer 220 is formed on the insulating layer 300 (S100), a second black matrix layer 420 is formed on the second electrode layer 220 (S200), a second black matrix pattern 420 is formed by patterning the second black matrix layer (S300), and a second electrode pattern 220 of a pattern type corresponding to the second black matrix pattern 420 may be formed by etching the second electrode layer 220 (S400).

The second black matrix 420 may be patterned through a process of disposing and then exposing a mask on the second black matrix and then developing it with a developer, and the second electrode 220 may be etched in the same pattern and shape as the second black matrix 420 by using the second black matrix as a photoresist.

Since a photosensitive resist for a black matrix is used when patterning the second electrodes through the process, it is possible to form a second electrode pattern and a second black matrix pattern for reducing the reflectivity of the second electrodes in the same pattern size and shape and it is also possible to simplify the manufacturing process because the process of removing a photosensitive resist is omitted. Further, since the second electrodes and the second black matrixes are formed in the same pattern shape and width (size) through this process, it is possible to further improve the visibility of the touch screen panel. Further, as shown in FIG. 5 and FIG. 4e, a protective layer 600 may be additionally formed on the front surface after the second electrode pattern 220 and the second black matrix pattern 420 are formed.

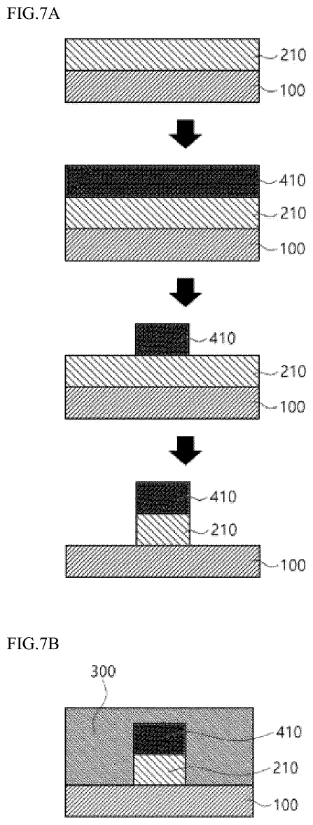

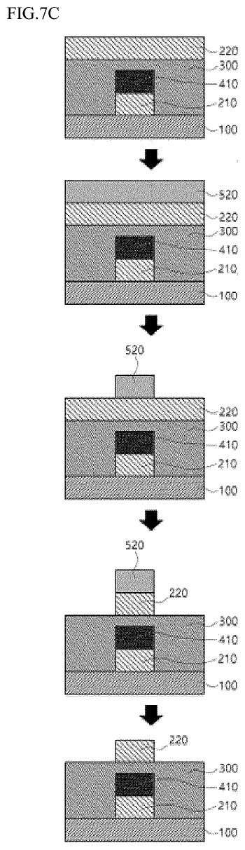

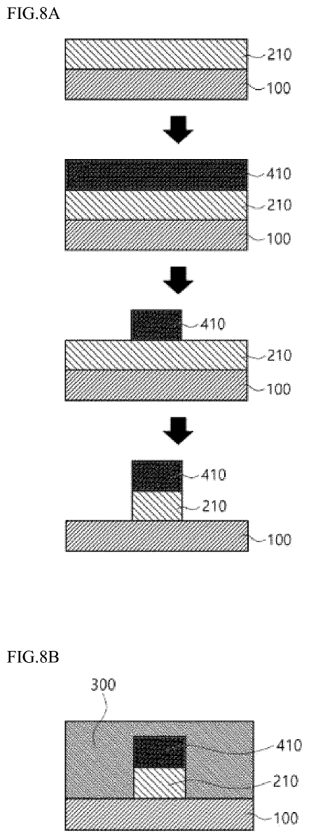

FIG. 7a to FIG. 7c shows step by step a process of manufacturing a touch screen panel including a structure in which a first black matrix 410 is formed on a first electrode 210 in an embodiment of the present disclosure.

First, first electrodes 210 are formed in a first pattern type on a base 100 (S10). As shown in FIG. 4a, the first pattern may be a lattice pattern, and in detail, as shown in the enlarged view of FIG. 4a, may be composed of a plurality of first electrodes arranged in a first direction and connected to each other into one pattern.

As for patterning of the first electrodes 210, as shown in FIG. 7a, a first electrode layer 210 is formed on a base 100 (S100), a first black matrix layer 410 is formed on the first electrode layer 210 (S200), a first black matrix pattern 410 is formed by patterning the first black matrix layer (S300), and then a first electrode pattern 210 of a pattern type corresponding to the first black matrix pattern 410 may be formed by etching the first electrode layer 210 using the first black matrix pattern 410 (S400).

The first black matrix 410 may be patterned through a process of disposing and then exposing a mask on the first black matrix and then developing it with a developer, and the first electrode 210 may be etched in the same pattern and shape as the second black matrix 420 by using the second black matrix as a photoresist.

A photosensitive resist for a black matrix is used when patterning the first electrodes through the process, it is possible to form a first electrode pattern and a first black matrix pattern for reducing the reflectivity of the first electrodes in the same pattern size and shape and it is also possible to simplify the manufacturing process because the process of removing a photosensitive resist is omitted. Further, since the first electrodes and the first black matrixes are formed in the same pattern shape and width (size) through this process, it is possible to further improve the visibility of the touch screen panel.

Next, an insulating layer 300 is formed on the base 10 on which the first electrodes 210 are formed (S20). Referring to FIG. 7b, the insulating layer 300 is applied to the base 100 and the first electrodes 210 on which the first black matrixes are formed, so it can fill the portions between the plurality of first electrodes 210 connected in a lattice pattern.

Coating known in the art may be used as the method of applying the insulating layer 300. For example, spin coating, die coating, spray coating, roll coating, screen coating, slit coating, deep coating, gravure coating, etc. may be used.

The insulating layer 300 may be formed to have a plurality of insulating patterns. The plurality of insulating patterns may have a plurality of openings for electrically connecting first electrodes and second electrodes to each other, and in detail, the insulating layer 300 may be patterned to have contact holes for at least partially connecting the first electrodes 210 and the second electrodes 220 to each other and may also be patterned such that the insulating layer 300 is formed like islands at the joints of many first electrodes 210.

Next, second electrodes 220 are formed in a second pattern type on the insulating layer 300 (S30). The second pattern may be a lattice pattern or a bar type connecting pattern electrically connecting a plurality of adjacent first electrode patterns, and in detail, may be composed of a plurality of second electrodes 220 arranged in a second direction crossing the first direction and not connected to each other.

In detail, referring to FIG. 7c, a second electrode 220 is formed on the insulating layer 300 and patterning is applied to the second electrode 220 through photolithography using a photosensitive resist 520, whereby a second electrode pattern layer may be formed. In this case, the photosensitive resist 520 is removed after the second pattern layer 220 is formed.

Further, a protective layer (not shown) may be additionally formed on the front surface after the second electrode 220 is formed.

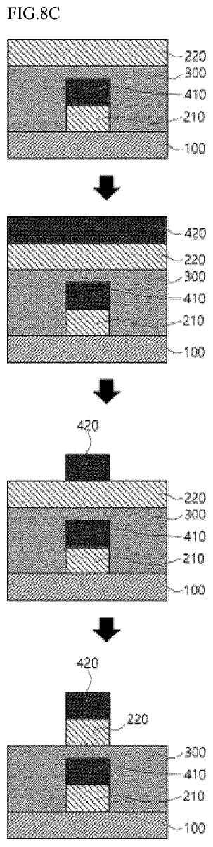

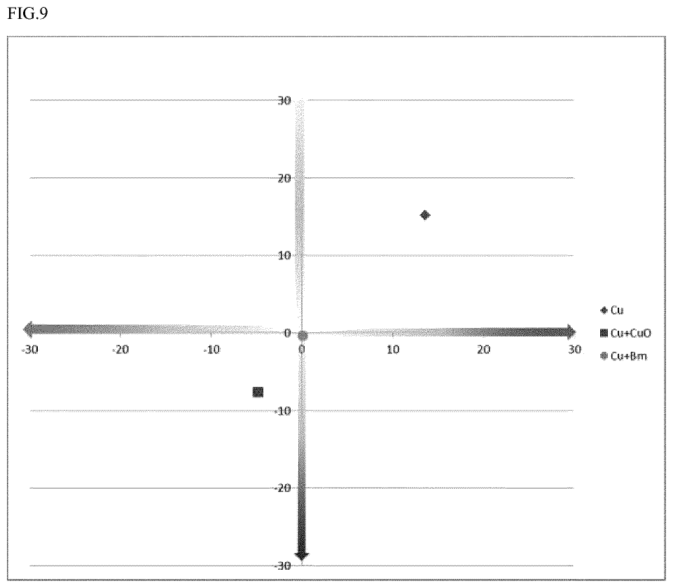

FIG. 8a to FIG. 8c show step by step a process of manufacturing a touch screen panel including a structure in which first black matrixes 410 and second black matrixes 420 are formed on first electrodes 210 and second electrodes 220, respectively, in an embodiment of the present disclosure.

First, first electrodes 210 are formed in a first pattern type on a base 100 (S10). As shown in FIG. 4a, the first pattern may be a lattice pattern, and in detail, as shown in the enlarged view of FIG. 4a, may be composed of a plurality of first electrodes arranged in a first direction and connected to each other into one pattern.

As for patterning of the first electrodes 210, as shown in FIG. 8a, a first electrode layer 210 is formed on a base 100 (S100), a first black matrix layer 410 is formed on the first electrode layer 210 (S200), a first black matrix pattern 410 is formed by patterning the first black matrix layer (S300), and then a first electrode pattern 210 of a pattern type corresponding to the first black matrix pattern 410 may be formed by etching the first electrode layer 210 using the first black matrix pattern 410 (S400). The first black matrix 410 may be patterned through a process of disposing and then exposing a mask on the first black matrix and then developing it with a developer, and the first electrode 210 may be etched in the same pattern and shape as the second black matrix 420 by using the second black matrix as a photoresist.

Next, an insulating layer 300 is formed on the base 10 on which the first electrodes 210 and the first black matrixes 410 are formed (S20). Referring to FIG. 8b, the insulating layer 300 is applied to the base 100 and the first electrodes 210 on which the first black matrixes 410 are formed, so it can fill the portions between the plurality of first electrodes 210 connected in a lattice pattern.

Coating known in the art may be used as the method of applying the insulating layer 300. For example, spin coating, die coating, spray coating, roll coating, screen coating, slit coating, deep coating, gravure coating, etc. may be used.

The insulating layer 300 may be formed to have a plurality of insulating patterns. The plurality of insulating patterns may have a plurality of openings for electrically connecting first electrodes and second electrodes to each other, and in detail, the insulating layer 300 may be patterned to have contact holes for at least partially connecting the first electrodes 210 and the second electrodes 220 to each other and may also be patterned such that the insulating layer 300 is formed like islands at the joints of many first electrodes 210.

Next, second electrodes 220 are formed in a second pattern type on the insulating layer 300 (S30). The second pattern may be a lattice pattern or a bar type connecting pattern electrically connecting a plurality of adjacent first electrode patterns, and in detail, as shown in FIG. 4d, may be composed of a plurality of second electrodes 220 arranged in a second direction crossing the first direction and not connected to each other.

As for the second electrodes 220, as shown in FIG. 8c, a second electrode layer 220 is formed on the insulating layer 300 (S100), a second black matrix layer 420 is formed on the second electrode layer 220 (S200), a second black matrix pattern 420 is formed by patterning the second black matrix layer (S300), and a second electrode pattern 220 of a pattern type corresponding to the second black matrix pattern 420 may be formed by etching the second electrode layer 220 (S400).

The first black matrix 410 may be patterned through a process of disposing and then exposing a mask on the first black matrix and then developing it with a developer, and the first electrode 210 may be etched in the same pattern and shape as the second black matrix 420 by using the second black matrix as a photoresist.

A photosensitive resist for a black matrix is used when patterning the first electrodes and the second electrodes through the process, it is possible to form a first electrode pattern and a first black matrix pattern for reducing the reflectivity of the first electrodes in the same pattern size and shape and it is also possible to omit the process of removing a photosensitive resist. Further, since electrodes and matrixes are formed in the same pattern shape and width (size) through this process, it is possible to further improve the visibility of the touch screen panel.

Further, a protective layer (not shown) may be additionally formed on the front surface after the second electrodes 220 and the second black matrixes 420 are formed.

### MODE FOR INVENTION

Hereafter, the present disclosure is described in more detail through an embodiment. However, the following embodiment is provided to describe the present disclosure in more detail and the range of the present disclosure is not limited by the following embodiment.

### Example 1

A touch screen panel (Example1) in which black matrixes are formed on copper electrodes was manufactured through the method according to the present disclosure and then reflective color schemes were shown in the following Table 1 and FIG. 9. In FIG. 9, the left minus (−) direction means green and the right plus (+) direction means red on the x axis, and the downward minus (−) direction means deep blue and the upward plus (+) direction means yellow on the y axis.

### Comparative Examples 1 and 2

A touch screen panel in which black matrixes are not formed on copper electrodes (Comparative example 1) and a touch screen panel in which a copper oxide layer is formed on copper electrodes (Comparative example 2) were manufactured and then reflective color schemes thereof were shown in the following Table 1 and FIG. 9.

TABLE 1

| Reflection | Y(D65) | a*(D65) | b*(D65) |
|---|---|---|---|
| Comparative | 72.0 | 13.6 | 15.2 |
| example 1 (Cu) | | | |
| Comparative | 15.4 | −4.8 | −7.6 |
| example 2 (Cu + | | | |
| CuO) | | | |
| Example 1 (BM) | 6.0 | 0.1 | −0.4 |

In Table 1, F is reflectivity and a* and b* are color schemes.

As shown in Table 1 and FIG. 9, it could be seen that reflectivity remarkably decreased and visibility close to black was shown in Example1 in which black matrixes are formed on electrodes.

### INDUSTRIAL APPLICABILITY

The touch screen panel of the present disclosure is for improving visibility by reducing reflectivity of electrodes by forming black matrixes on electrodes in order to solve the problem that an electrode pattern is shown due to reflectivity of electrodes positioned in a display region.

1. A touch screen panel comprising:
a base:
first electrode formed in a first pattern type on the base;
an insulating layer formed on the base on which the first electrodes are formed; and
second electrode formed in a second pattern type on the insulating layer,
wherein black matrixes of a pattern type corresponding to one or more electrodes selected from the first electrodes and the second electrodes are formed on the electrodes.

2. The touch screen panel of claim 1, wherein the first pattern of the first electrodes and a pattern of the black matrixes disposed on the first electrodes have the same width.

3. The touch screen panel of claim 1, wherein the second pattern of the second electrodes and a pattern of the black matrixes disposed on the second electrodes have the same width.

4. The touch screen panel of claim 1, wherein the first pattern and the second pattern are independent lattice patterns.

5. The touch screen panel of claim 1, wherein the first electrodes and the second electrode are at least partially connected to each other.

6. The touch screen panel of claim 1, wherein the first pattern includes many first electrodes arranged in a first direction and connected to each other in one pattern and the second pattern include many second electrodes arranged in a second direction crossing the first direction and not connected to each other.

7. A method of manufacturing a touch screen panel, the method comprising:
a step of forming first electrodes in a first pattern type on a base;
a step of forming an insulating layer on the base on which the first electrodes are formed; and
a step of forming second electrodes in a second pattern type on the insulating layer,
wherein one or more electrodes selected from the first electrodes and the second electrodes are formed by a pattern forming method including:
a step of forming an electrode layer;
a step of forming a black matrix layer on the electrode layer;
a step of forming a black matrix pattern by patterning the black matrix layer; and
a step of forming an electrode pattern of a pattern type corresponding to the black matrix pattern by etching the electrode layer using the black matrix pattern.

8. The method of claim 7, wherein the step of forming first electrodes includes forming many first patterns arranged in a first direction and connected to each other in one pattern, and
the step of forming second electrodes includes forming many second patterns arranged in a second direction crossing the first direction and not connected to each other.

9. The method of claim 7, further comprising a step of forming a protective layer after the step of forming second electrodes.

10. The method of claim 7, wherein the black matrix pattern is not removed.
